(19) United States
(12) Patent Application Publication
(10) Pub. No.: US 2003/0005812 A1
(43) Pub. Date: Jan. 9, 2003

(54) STICK TYPE BASS DRUM MALLET

(76) Inventors: Robert N. Geyer, Thousand Oaks, CA (US); Paul V. Zbrzezny, Burbank, CA (US)

Correspondence Address: Robert N. Geyer, 862 Calle Pensamiento, Thousand Oaks, CA, 91360, US

(21) Appl. No.: 09/753,741

(22) Filed: Jan. 3, 2001

(51) Int. Cl. G10D 13/02

(52) U.S. Cl. 84/422.4

(57) ABSTRACT

A stick type bass drum mallet is disclosed which includes a plurality of elongated, substantially straight, wooden, bamboo or nylon rods in which surround a metal shaft to form a bundle. At least one retainer is needed to secure the bundle tightly together where the shaft is inserted into the bundle. A second retainer may be added to the striking end for tonal differences.

### BACKGROUND OF THE INVENTION

1. Field of the Invention

The present invention relates to the bass drum mallet and more particularly to a unique stick type bass drum mallet, with improved percussive characteristics

2. Description of the prior Art

In the prior art there have been two basic type of bass drum mallets. The felt type, which produces a dead, low, bass sound and a wooden type which produces a low bass sound with more attack. In prior art bass drum mallets where made with a metal shaft which supported a ball like head made of solid wood, felt or wrapped yarn. The end with the ball like head typically was used for striking the bass drum.

There remains, however, a need in the bass drum mallet art for a new and distinctive type of bass drum mallet which offers an improved percussive sound, which can not be achieved by the prior art solid, ball shaped mallet configuration.

### SUMMARY OF THE INVENTION

By the means of the present invention there is provided a new stick type bass drum mallet which achieves improved percussive resonance and tonal qualities while retaining the rigidity required for the reverberation desired in loud drum passages.

The bass drum mallet of the present invention includes a bundle of elongated, substantially strait rods, which are preferably, round hard wood or nylon dowels. The bundle is assembled without a longitudinal axis accept for a short portion at the butt where the shaft is inserted. The dowels are individually bound together and also to the shaft with adhesives and or rigid tape.

A pin is placed just below the bundle and directly through the shaft. A plastic cap is then slid down the shaft up to and around the bundle. The inside of the cap is adhered to the base of the bundle and the pin secures the shaft from pulling out of the bundle when being used.

The purpose of the shaft is so the present invention can be mounted to a bass drum pedal. There for, to be played with the feet as apposed to the hands. An additional cap may be added to the striking end of the bundle for a more traditional tone. The combination of the bundle of dowels and the mountable shaft yields a stick type bass drum mallet, which produces extraordinary good tonal qualities, which never could be achieved with the foot before.

### BRIEF DESCRIPTION OF THE DRAWINGS

In the drawings where in like numeral are used to depict like parts throughout the same.

FIG. 1 is a side view of the stick type bass drum mallet constructed in accordance with one embodiment of the present invention.

FIG. 2 is a cross sectional view along line 2-2 of FIG. 1

FIG. 2A is a cross sectional view depicting an alternate embodiment of the present invention along line 2-2 of FIG. 1

FIG. 2B is a cross sectional view depicting another alternate embodiment of the present invention along line 2-2 of FIG. 1

FIG. 2C is a cross sectional view depicting yet another alternate embodiment of the present invention along line 2-2 of FIG. 1

FIG. 3 is a side view depicting an alternate embodiment of the present invention

FIG. 3A is a side view of another alternate embodiment of the present invention.

FIG. 3B is a side view of yet another alternate embodiment of the present invention.

FIG. 4 is a side view depicting the application of the invention

FIG. 5 is a side view depicting the assembly of the present invention.

FIG. 5A is a side view depicting an alternate assembly of the invention

FIG. 5B is a side view depicting yet another alternate assembly of the invention.

### DESCRIPTION OF THE PREFERRED EMBODIMENTS

FIG. 1 depicts an embodiment of a stick type bass drum mallet 10 fabricated in accordance with the present invention. The mallet includes a plurality of substantially straight elongated wooden rods 11 which are disposed to form a bundle, without a longitudinal axes. The playing ends of which are preferable aligned in a substantially flat or planner playing end surface as at 12 except for the outer edges of the bundle which are preferable rounded at 13.

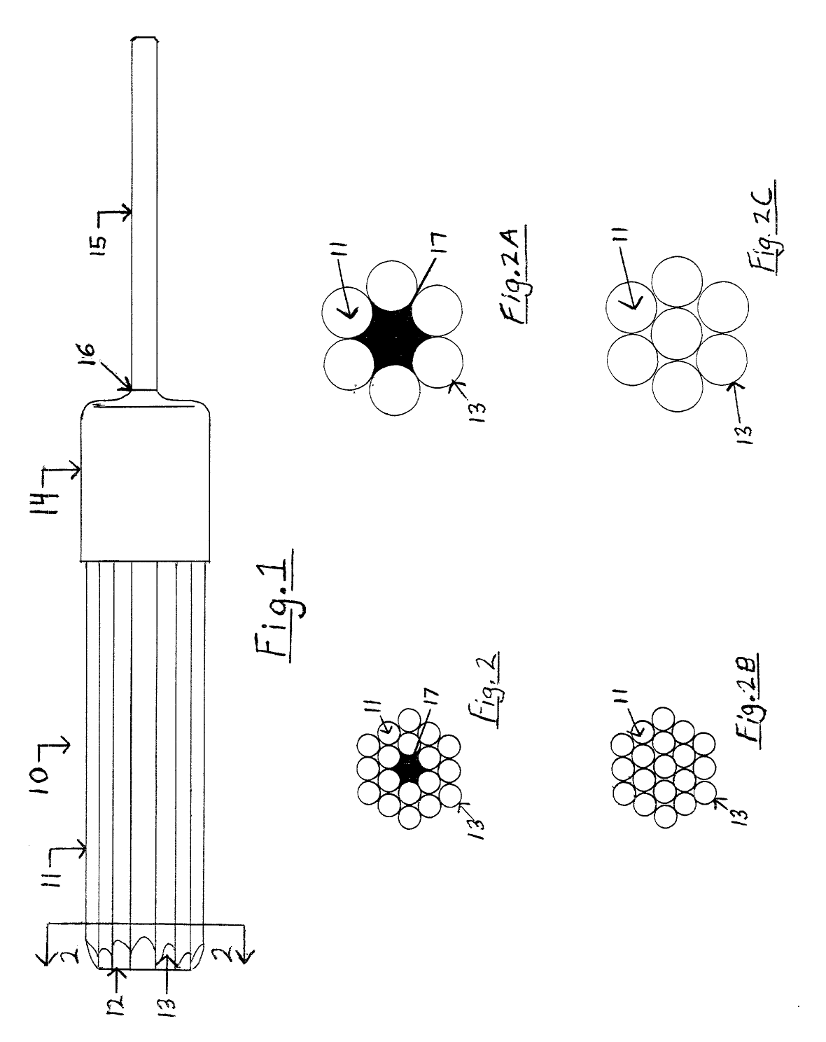

A rubber cap 14 is placed around the bundle opposite the playing end to secure the dowels. Adhesives secure The dowels to each other and also secure the bundle to the inside of the cap. A metal type shaft 15 is inserted threw the center of the cap and into the hollow center of the bundle 17 of FIG. 2 at 16. Adhesives secure the hollow center of the bundle to the shaft. A pin is inserted through the shaft and in between the bundle and the cap to secure the shaft to the bundle

It would be appreciated that the rods of the present invention may be fabricated of any plurality of wood, nylon, bamboo solid and or hollow dowels, which have the required degree of stiffness and resilience desired.

As shown in FIG. 2 the preferable cross-sectional shape of the rods is round and dowel material has been found to work well. The particular number of rods may vary with the application and size of the rods used. It has been found, however, that when 18 or 6 rods are used the cross section of the bundle formed takes on a hexagonal geometry. This is convenient and desirable for fitting the bundle into the round cap properly.

The cap material may also be any material capable of causing a fairly rigid binding of the bundle of rods. It is preferable a material which takes on the shape of the bundle, such as the hexagonal shape mentioned. This is a material such as plastic, rubber, nylon and P.V.C.

The shaft should be made by a material strong enough to withstand mass torque. This is a material such as steel, metal or zinc. The shaft should consist of some type of fastener to secure it to the bundle. Some preferable fasteners are a spring pin and or a washer and nut. The shaft would need to be threaded to use the nut and washer mentioned above. One successful embodiment has been fabricated by the procedure as follows. One ¼″ diameter stainless steel rod 5 and ½″ long consisting spring pin 1/16″ which is mounted perpendicularly directly through the rod at 1 and ½″ from the opposite end of the butt. A bundle of 18×¼″ diameter wooden dowels 4 and ½″ long are adhered together in a 1 and ½″ section opposite the striking end. The shaft is then inserted into the hollow center of the bundle up to the point where the pin is flush with the base of the dowels. The shaft is also adhered to the inside of the bundle during this process. A plastic cap land ½″×1 and ¼″ with a ¼″ whole is slid down the shaft up to and over the bundle. The inside of the cap is adhered to the bundle.

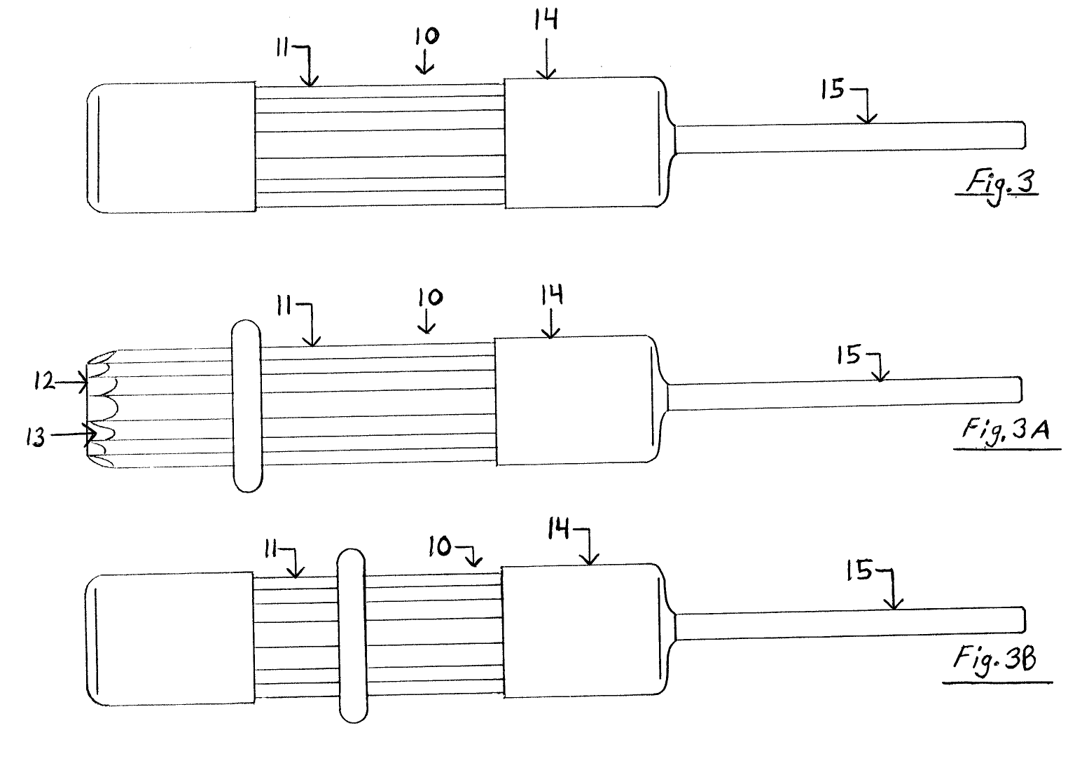

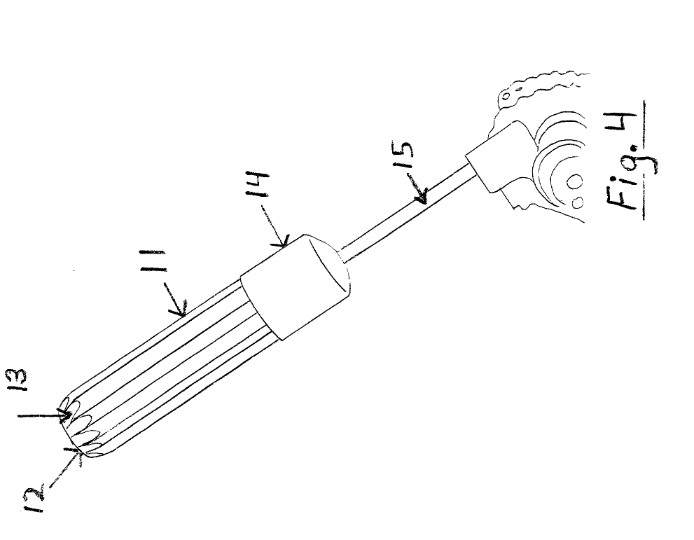

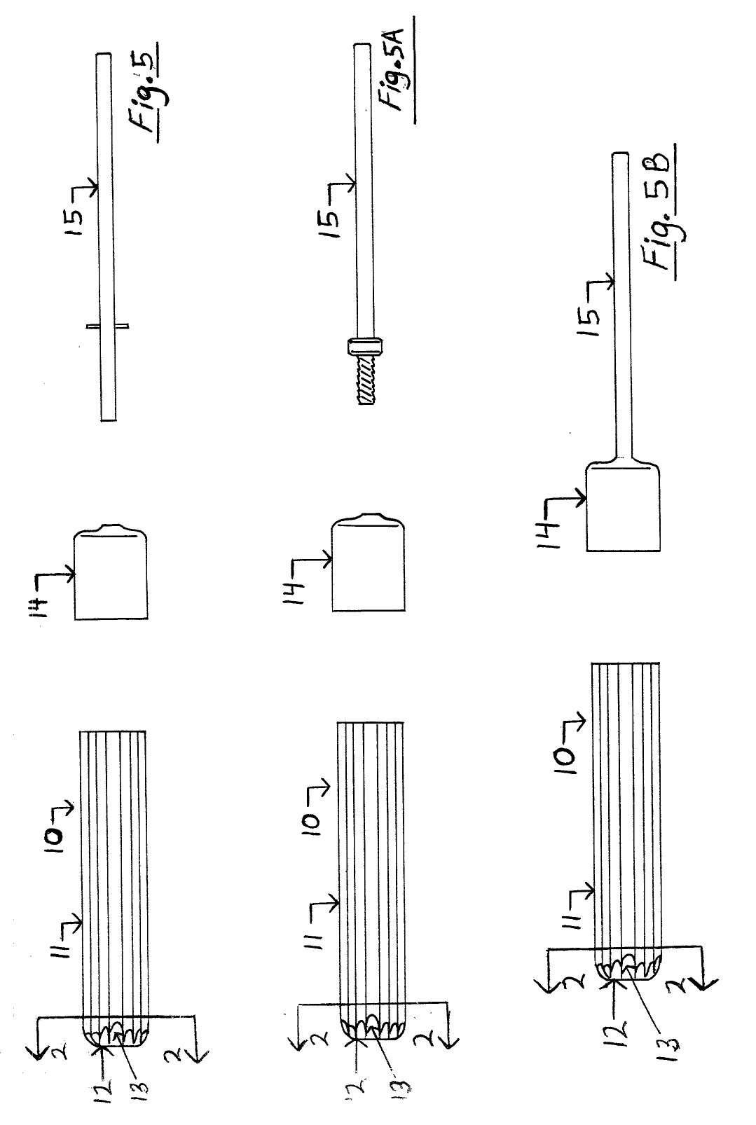

Bass drum mallets fabricated in accordance with the present invention are slitely more flexible than the solid wood or felt mallets. The interaction of the wooden rods among them selves when the mallet strikes the drum adds desirable tonal qualities to the percussive sound of the drum. This cannot be achieved with traditional solid mallets. Using an adjustable sleeve as shown in the embodiment of FIG. 3A may vary these tonal qualities. As previously discussed, an additional cap can also be added to the striking end to achieve a nore traditional tonal quality.

The embodiments of the invention in which an exclusive property or right is claimed are defined as follows:

1. A stick type bass drum mallet comprising:
A plurality of elongated, subtastantially straight wooden rods disposed to form a bundle, Said bundle having two ends and no longitudinal axis, except for a short span at the butt Where a mountable shaft is inserted; First retaining means securing said bundle tightly Together in a cap like manner for a short longitudinal span opposite the striking end Where said shaft is inserted into the bundle.

2. The bass drum mallet of claim 1 comprising of second retaining means, bindings Said bundle tightly together in a band like manner for a very short longitudinal Span and which is adjustable by rolling up or down said bundle anywhere above said Bundle first retaining means.

3. The bass drum mallet of claim 1 further comprising third retaining means binding said Bundle tightly together in a cap like manner for a short longitudinal span at the striking end of said bundle.

4. The bass drum mallet of claim 1 comprising the combination of said second retaining means and said third retaining means of claims 2 and 3.

5. The bass drum mallets of claim 1 where in said rods are nylon.

6. The bass drum mallets of claim 1 where in said rods are a combination of wood and nylon.

7. The bass drum mallet of claim 1 where in said rods is round in cross section.

8. The bass drum mallet of claim 7 where in the number of said rods is such that when bundled together, the bass drum mallet acquires a substantially hexagonal cross-sectional shape.

9. The bass drum mallet of claim 8 where the number of rods is 18.

10. The bass drum mallet of claim 8 where in the number of rods is 6.

11. The bass drum mallet of claim 7 where in the number of rods is such that when bundled together, the bass drum mallet acquires a round cross-sectional shape.

12. The bass drum mallet of claim 11 where in the rods is substantially thinner.

13. The bass drum mallet of claim 11 where in said bundle consists of any plurality of said rods.

14. The bass drum mallet of claim 1 where in a spring pin is installed perpendicularly and directly through said shaft at the location flush with said bundle opposite the striking end and in between said first retaining means.

15. The bass drum mallet of claim 14 where in said shaft is threaded for a short span at the location which is inserted into said bundle and secured with a washer inside said first retaining means and flush with said bundle opposite striking end. A lock nut at location flush with bottom of said first retaining means.

16. The bass drum mallet of claim 14 where in said shaft and first retainers are one piece.

17. The bass drum mallet of claim 1 where said first retaining means includes an amount of adhesive.

18. The bass drum mallet of claim 1 comprising of a longitudinal axis.

19. The bass drum mallet of claim 18 where in the number of rods is 19.

20. The bass drum mallet of claim 18 where in the number of rods is 7.
